(19) United States
(12) Patent Application Publication
(10) Pub. No.: US 2009/0321003 A1
(43) Pub. Date: Dec. 31, 2009

(54) PROCESS AND ASSEMBLY FOR PRODUCING A PLANAR APPLIQUE PATTERN FROM A TACKY SURFACED VINYL SHEET SUCH AS FOR APPLICATION AS A DECORATIVE WINDOW GRID PATTERN

(76) Inventor: Ronald A. Salada, Clinton Township, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/487,258

(22) Filed: Jun. 18, 2009

Related U.S. Application Data
(60) Provisional application No. 61/075,434, filed on Jun. 25, 2008.

(51) Int. Cl. B32B 38/10; B32B 3/10

(52) U.S. Cl. 156/247; 428/42.1

(57) ABSTRACT

A kit for creating a decorative overlay for applying to a surface, including a sheet of a flexible material constructed from a first layer with an adhesive underside and a second backing layer. A plurality of score lines are formed in the first layer and, upon removal of a plurality of subset portions from the surface layer which are bounded by score lines, reveals a decorative pattern. A temporary covering is applied over a finished (front) surface of the first layer and, subsequently, the adhesive backing layer is removed exposing the adhesive underside. The adhesive pattern, supported by the temporary covering, is then applied over the desired surface and the temporary sheet is removed leaving in place the adhesively applied decorative pattern.

### CROSS-REFERENCE TO RELATED APPLICATIONS

This Application claims the benefit of U.S. Provisional Application 61/075,434 filed on Jun. 25, 2008 and entitled KIT AND ASSEMBLY FOR PRODUCING A PLANAR APPLIQUE PATTERN FROM A TACKY SURFACED POLYMER SHEET SUCH AS A DECORATIVE WINDOW GRID PATTERN.

### FIELD OF THE INVENTION

The present invention is a multi-step process for creating a decorative faux overlay for application over a glass surface. The kit and assembly employs a planar sheet cutting machine for pre-incising a sheet of a peel-away vinyl material secured to a backing layer. Following removal of the incised portions, a temporary top covering is applied over the finished surface of the created pattern. Subsequently, the original backing layer is removed, exposing an adhesive surface of the nylon decorative pattern which is then press applied over the glass surface, at which point the temporary top sheet is removed.

### BACKGROUND OF THE INVENTION

The prior art is documented with various appliqué articles and methods. These include the method for applying designs to a substrate as set forth in Erickson, U.S. Pat. No. 6,773,537 and the method and apparatus for applying aligned tape patterns in Briese U.S. Pat. Nos. 7,105,068 and 7,311,793. Other references, such as Thunhorst U.S. Pat. No. 7,311,793, teach a laminate from which decorative films can be precisely applied to a substrate.

### SUMMARY OF THE INVENTION

The present invention discloses a kit for creating a decorative overlay for applying to a surface, this including a sheet of a flexible material constructed from a first layer with an adhesive underside and a second attached backing layer. A plurality of score lines are formed in the first layer and, upon removal of a plurality of subset portions from the surface layer which are bounded by score lines, reveals a decorative pattern.

A temporary covering (such as a statically engageable and easily removable layer) is then applied over a finished (front) surface of the first layer and, subsequently, the adhesive backing layer is removed in order to expose the adhesive underside. The adhesive pattern, supported by the temporary covering, is then applied over the desired (typically glass) surface, at which point the temporary top sheet is peel away removed from the finished face of the underlying grip pattern, leaving in place the adhesively applied decorative pattern.

Additional features include the first layer being composed of a durable nylon sheet material. A sheet cutter and plotter is also provided for creating incised patterns in at least the first layer when attached to the second backing layer. The temporary covering further includes at least one of a polymeric or a wax paper material.

### BRIEF DESCRIPTION OF THE DRAWINGS

Reference will now be made to the attached drawings, when read in combination with the following detailed description, wherein like reference refer to like parts throughout the several views, and in which:

FIGS. 1A-1C are multi-step illustrations describing the application of a sheet cutter and plotter for creating incised patterns in a composite sheet constructed of a first vinyl or nylon adhesive backed sheet to which is attached an original backing layer;

FIG. 2 is an exploded view illustrating the application of a temporary and minimally adhesive retaining top covering over a finished surface of the created pattern;

FIG. 3 is an inverted illustration showing the assembled original backing layer, partially peeled-away to reveal an adhesive underside of the decorative pattern and the temporary applied covering;

FIG. 3A is a partial illustration of exaggerated thickness and showing the original backing layer, decorative layer, and temporary applied covering of FIG. 3;

FIG. 4 is an environmental illustration showing, upon removal of the original backing layer, the adhesive revealed surface of a diamond shaped decorative pattern press applied over a glass surface, following which point the temporary top sheet is removed; and

FIG. 5 is an illustration similar to FIG. 4 and illustrating a square shaped decorative pattern created utilizing the kit and method according to the present invention.

### DETAILED DESCRIPTION OF THE PREFERRED EMBODIMENTS

Referring now to the drawing illustrations, the present invention discloses a decorative (e.g. faux) pattern, such as a diamond or square shaped grid pattern constructed of a sheet of incised polymeric (such as nylon) material and which is intended to mimic the effects of a wood or other surface applied covering or reinforcing support in use with a glass substrate. The kit and assembly described herein replicates such a visual appearance, this additionally mimicking the look of a unique decorative and/or new window application.

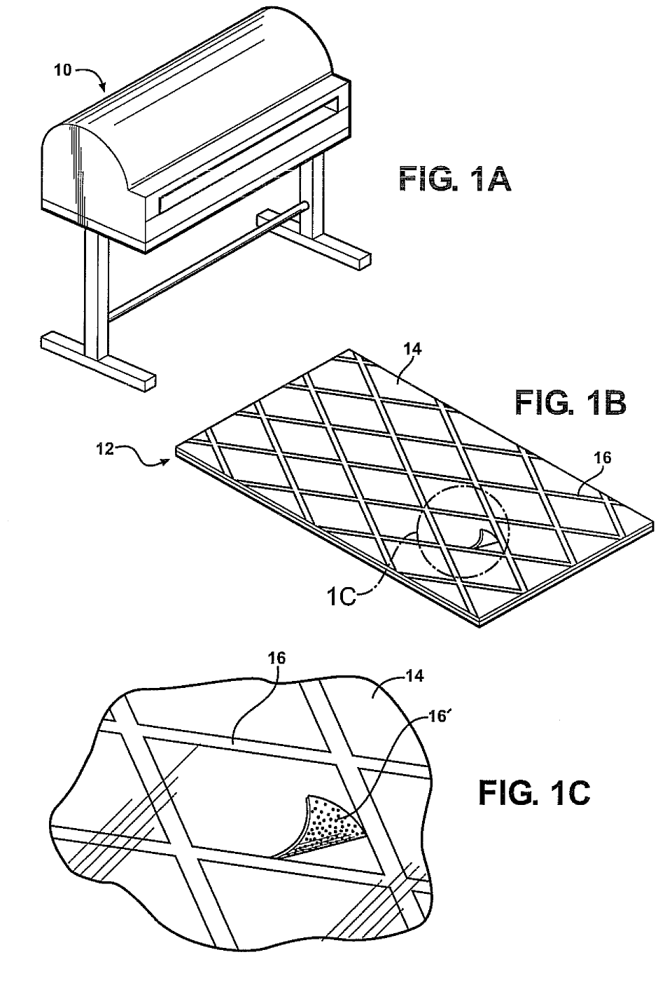

Referring to FIGS. 1A-C, a multistep illustration is shown and which describes the application of a sheet cutter and plotter, at 10 (FIG. 1A), which is utilized for creating incised patterns in such as a vinyl (or other polymeric) and adhesive backed sheet attached to an original backing layer. Such known sheet incising devices 10 typically employ a digitally controlled servo system for guiding the movement of a knife element.

The decorative sheet of material, generally shown at 12 in FIG. 1B, is constructed as a two ply composite and includes a backing layer 14 and a surface applied layer 16. The sheet material can exhibit any desired width and is usually provided in roll-form The layers 14 and 16 are further selected from suitable flexible materials, with at least the surface applied layer (or first layer) 16 including such as a vinyl or nylon material having a finished top surface and an adhesive backed surface.

FIG. 1B illustrates the two layer sheet 12 exhibiting a decorative pattern and following being processed through the cutter and plotter 10. At this stage the surface applied layer (e.g. the nylon surface) 16 exhibits a continuous surface, applied over the original backing layer 14, and into which a desired pattern has been incised through the manipulation of the knife portion (not shown) associated with the cutter 10. The knife associated with the incising device 10 is further understood to be sufficiently and finely dimensioned so that it, in operation, incises only the upper surface layer 16 without also sectioning the backing layer 14. That said, it is also envisioned that the cutter 10 can be reconfigured to incise or score through both the layers 14 and 16 without departing from the scope of the invention.

Referring further to FIG. 1C, an enlarged inset portion (also shown in FIG. 1B) illustrates scored subset areas, see for example at 16′ which are outlined by the knife cutter/plotter 10. At this point, each of the scored subset areas are peel-away removed from the backing layer 14 (or in the instance of the backing layer 14 also being incised such portions being removed along with their corresponding surface subset areas 16′).

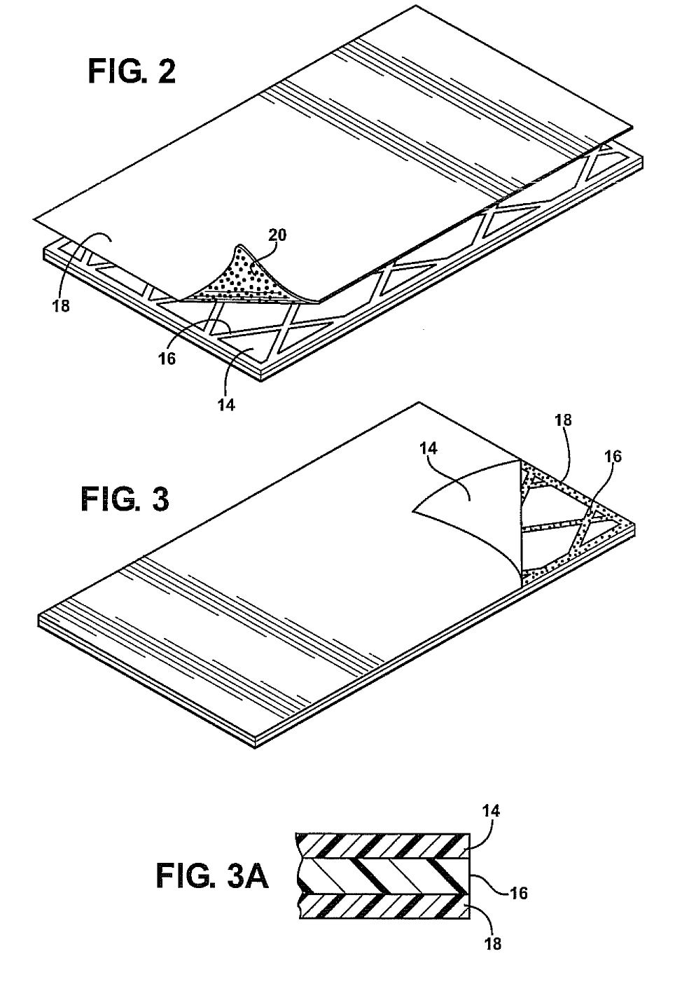

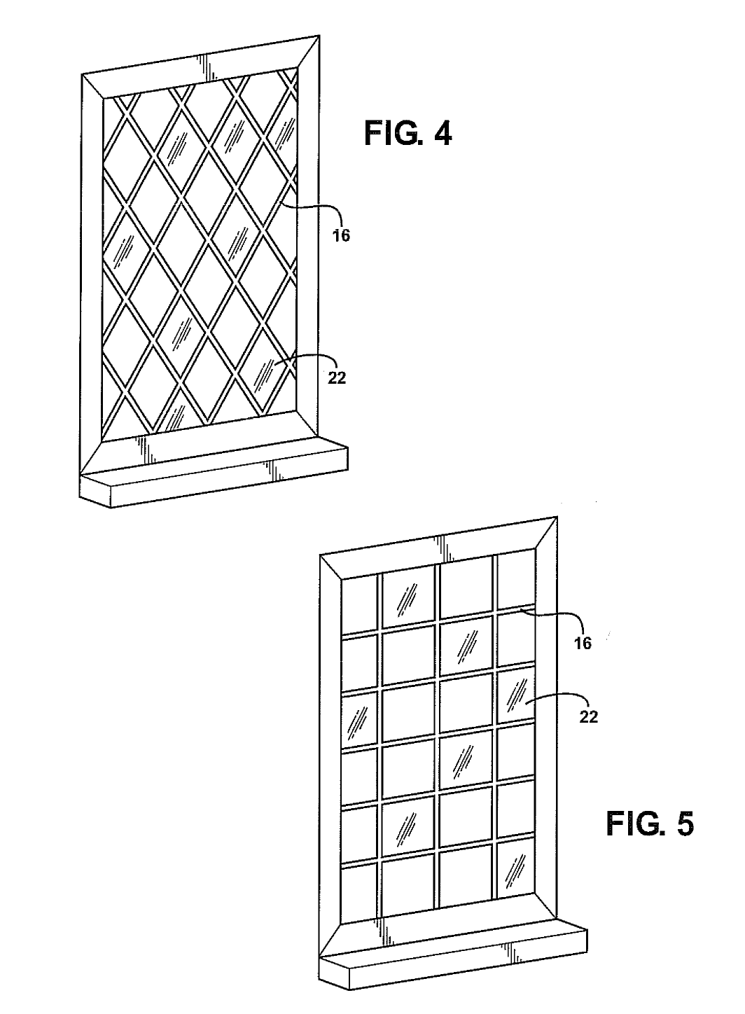

Referring now to FIG. 2, an exploded view illustrates the application of a temporary and minimally adhesive retaining top covering, see at 18, over a finished surface of the created pattern 16 in FIG. 1. Peel away flap portion of temporary covering 18 exhibits a minimal retaining adhesive, further at 20, it also being understood that a static cling or other minimal retention structure can be employed for releasably engaging the temporary flexible covering 18 over the exposed finished surface of the decorative pattern 16 (again following removal of all scored portions 16′ referenced in FIG. 5C). The temporary top covering is, in one variant, a likewise polymeric layer but can also include such as wax paper exhibiting an adequate tacky underside so that, upon application to the exposed and finished decorative layer 16, it is retained thereto until removed as described in FIG. 4.

FIG. 3 shows an inverted and assembled illustration of the original backing layer 14, partially peeled-away to reveal an adhesive underside of the decorative (grid shaped or cutout) pattern 16 and the temporary applied covering 18. FIG. 3A is a partial illustration of exaggerated thickness and showing the original backing layer 14, decorative layer 16, and temporary applied covering 18 in the arrangement of FIG. 3.

Referring to FIG. 4, an environmental illustration shows, upon removal of the original backing layer 14, the adhesive revealed surface 16 of the decorative pattern press applied over a glass surface, see at 22. Following this, the temporarily applied top sheet 18 is removed and the finished appliqué exhibited and such as which again depicts a generally diamond shaped pattern.

Finally, and referring to FIG. 5, an illustration similar to FIG. 4 is provided and illustrates a square shaped decorative pattern constructed from a reconfiguration of the cutter and plotter 10 in order redefine the incising arrangement applied to the surface (first) layer 16, this resulting from an alternately program employed with the sheet cutter and plotter and created utilizing the kit and method according to the present invention. It is further understood and envisioned that any desired decorative appliqué pattern can be created, which is only limited by the ability of the cutter/plotter assembly 10 to score the surface layer 16.

A corresponding method for creating a decorative overlay most broadly includes the steps of providing a composite sheet of material including a first layer with an adhesive underside and a second backing layer, incising a plurality of score lines in the first layer, and removing a plurality of subset portions bounded by the score lines to reveal a decorative pattern. Additional steps include applying a temporary covering over the first layer, removing the backing layer to expose the adhesive underside of the first layer, applying the temporary covering and exposed adhesive underside over a surface, and removing the temporary covering.

Having described my invention, other and additional preferred embodiments will become apparent to those skilled in the art to which it pertains, and without deviating from the scope of the appended claims. In particular, the kit and process for creating and applying a decorative overlay pattern can encompass applying matching grids to opposite sides of a glass (or other transparent/translucent) surface. The kit and process provides a decorative appealing appearance and can also generate the appearance of new windows and/or glass doors.

I claim:

1. A kit for creating a decorative overlay for applying to a surface, comprising:
a composite sheet of material including a first layer with an adhesive underside and a second backing layer;
a plurality of score lines formed in said first layer and, upon removal of subset portions bounded by said score lines, revealing a decorative pattern; and
a temporary covering applied over said first layer such that, upon successive removal of said backing layer exposing said adhesive underside, said temporary covering and adhesively revealed first layer are applied over the surface, at which point said covering is removed.

2. The kit as described in claim 1, said first layer further comprising at least one of a vinyl or nylon sheet material.

3. The kit as described in claim 1, further comprising a sheet cutter and plotter for creating incised patterns in at least said first layer when attached to said second backing layer

4. The kit as described in claim 1, said temporary covering further comprising at least one of a polymeric or a wax paper material.

5. The kit as described in claim 1, said decorative pattern incorporating a diamond-shaped design.

6. The kit as described in claim 1, said decorative pattern incorporating a square shaped design.

7. A method for creating a decorative overlay, comprising the steps of:
providing a composite sheet of material including a first layer with an adhesive underside and a second backing layer;
incising a plurality of score lines in said first layer;
removing a plurality of subset portions bounded by said score lines to reveal a decorative pattern;
applying a temporary covering over said first layer;
removing said backing layer to expose the adhesive underside of said first layer;
applying said temporary covering and exposed adhesive underside over a surface; and
removing said temporary covering.

8. The method as described in claim 7, further comprising the step of providing said at least one of a vinyl or nylon sheet material.

9. The method as described in The kit as described in claim 1, further comprising a sheet cutter and plotter for creating incised patterns in at least said first layer when attached to said second backing layer.

10. The method as described in claim 1, further comprising the step of providing said temporary covering as at least one of a polymeric or a wax paper material.

11. The method as described in claim 1, further comprising the step of providing said decorative pattern incorporating a diamond-shaped design.

12. The method as described in claim 1, further comprising the step of providing said decorative pattern incorporating a square shaped design.
